(19) United States
(12) Patent Application Publication
(10) Pub. No.: US 2008/0285912 A1
(43) Pub. Date: Nov. 20, 2008

(54) INTEGRATED CIRCUIT WITH OPTICAL SWITCH

(75) Inventor: Shoaib Zaidi, Poughkeepsie, NY (US)

Correspondence Address: DICKE, BILLIG & CZAJA, FIFTH STREET TOWERS, 100 SOUTH FIFTH STREET, SUITE 2250, MINNEAPOLIS, MN, 55402, US

(73) Assignee: Qimonda North America Corp., Cary, NC (US)

(21) Appl. No.: 11/748,143

(22) Filed: May 14, 2007

(51) Int. Cl. G02B 6/26

(52) U.S. Cl. 385/16

(57) ABSTRACT

An integrated circuit having an optical switch includes an optical body configured to transmit light, the optical body having a boundary, and a thin film disposed at the boundary that is configured to selectively change a pseudo-Brewster angle of light reflected at the boundary.

### BACKGROUND

Optical switches are useful in the high-speed transmission of data. Optical circuits employing optical switches are useful in a variety of applications, including high speed signal processing, optical interconnects, telecommunication, flat panel displays, digital multiplexers, and computers, including chip-to-chip data communication and board-to-board data communication.

One type of optical switch is a thermal optical switch. The optical switch includes a waveguide having a core portion. An index of refraction of the core portion changes in response to a thermal input. The core portion has a thickness of several microns (e.g., 6 to 8 microns). Due to the core thickness, relatively large energy inputs are necessitated in order to affect a change in the index of refraction of the core portion.

Optical switches, whether employed as an individual switching element or in an array of optical switches, suffer reduced performance due to time delays in switching related to the heating and cooling of large volumes of core materials.

In addition, any intrinsic non-uniformity in a relatively thick core can result in signal destruction within an optical structure during thermal cycling. The material forming a core can be expensive, and the large volume of a core compounds this expense.

For these and other reasons, there is a need for the present invention.

### SUMMARY

One embodiment provides an integrated circuit having an optical switch. The optical switch includes an optical body configured to transmit light, the optical body having a boundary, and a thin film disposed at the boundary that is configured to selectively change a pseudo-Brewster angle of light reflected at the boundary.

### BRIEF DESCRIPTION OF THE DRAWINGS

The accompanying drawings are included to provide a further understanding of the description and are incorporated in and comprise a part of this specification. The drawings illustrate embodiments and together with the detailed description describe principles of the present invention. Other embodiments, and many of the intended advantages, will be readily appreciated as they become better understood by reference to the following detailed description. The elements of the drawings are not necessarily to scale relative to each other. Like reference numerals designate corresponding similar parts.

FIG. 1 is a simplified diagrammatical view illustrating an optical system according to one embodiment.

FIG. 2 is a simplified perspective view of an optical circuit of the optical system illustrated in FIG. 1.

FIG. 3 is a cross-sectional view of an optical switch of the optical circuit illustrated in FIG. 2 showing an optical boundary.

FIG. 4A is a graph of optical phase changes at the optical boundary for the optical switch illustrated in FIG. 3.

FIG. 4B is a composite graph of the relative optical phases for reflections at the optical boundary shown in FIG. 3.

FIG. 5 is a simplified side view of a light signal passing through a phase shifter of the optical circuit illustrated in FIG. 2.

FIG. 6 is a simplified side view illustrating a light signal transmitted through another optical switching circuit according to one embodiment.

### DETAILED DESCRIPTION

In the following Detailed Description, directional terminology, such as “top,” “bottom,” “front,” “back,” “leading,” “trailing,” etc., is used with reference to the orientation of the Figure(s) being described. Because components of the embodiments can be positioned in different orientations, the directional terminology is for the purpose of illustration only and is in no way intended to be limiting. It is to be understood that other embodiments may be utilized and structural or logical changes may be made, without departing from the scope of the present invention. The following detailed description, therefore, is not to be taken in a limiting sense, and the scope of the present invention is defined by the appended claims.

Embodiments generally provide an integrated circuit having an optical switch, and an optical system including optical circuits that transmit light signals. Information is carried by the light signals. In one embodiment, it is desired to selectively switch between a zero degree phase lag (signal transmission) to a 180 degree phase lag (signal interference) for signals entering and exiting the optical circuit. The phase lag in the optical signal, and thus information carried by the signal, can be selectively controlled by selectively increasing an optical path length through a portion of the circuit. Embodiments described below provide for increasing an optical path length through the circuit by increasing a refractive index in a switch of the circuit that enables selective phase lag shifting from a zero degree phase lag to a 180 degree phase lag.

Embodiments provide an optical switch that has an optical body suited for transmitting light, and a thin film coupled to the optical body, where the thin film is switchable between a first index of refraction of a first value to a second index of refraction of a different value. The optical circuit provides selective control of the refractive index in the thin film layer that enables selective control of the phase lag in optical signals passing through the optical circuit. Certain embodiments provide an efficient switch characterized by low energy and low current inputs to the thin film that result in a switch having high signal integrity and rapid cycling. In this specification, thin is defined as a material thickness less than 1 micron.

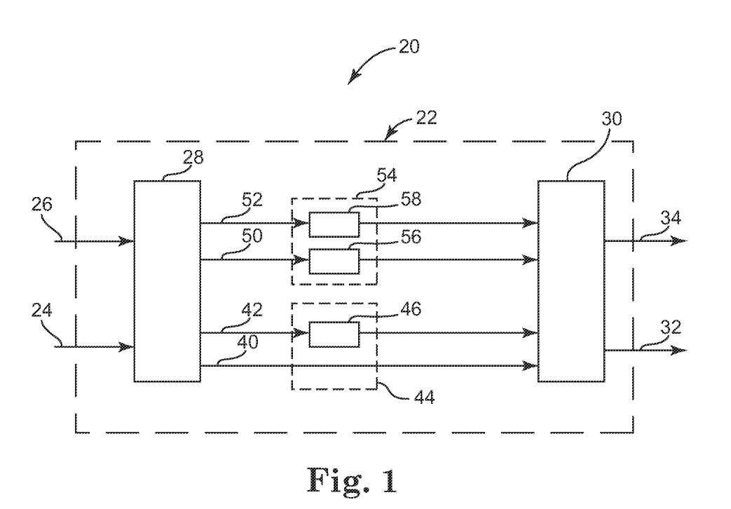

FIG. 1 is a simplified diagrammatical view illustrating an optical system 20 according to one embodiment. In one or more embodiments, optical system 20 is part of an integrated circuit. Optical system 20 is suitably coupled to an opto-electronic circuit or other electrical device. As used herein the terms “coupled” and “electrically coupled” are not meant to mean that the elements must be directly coupled together, and intervening elements may be provided between the “electrically coupled” elements.

Optical system 20 includes an optical circuit 22 having multiple light inputs 24, 26 that pass through an input coupler 28 and an output coupler 30 to provide optical signals 32, 34. In one embodiment, input coupler 28 includes a wave guide and/or opto-electronics suited for aligning light signals 24, 26 for signal transmission. Other suitable light pathways are also contemplated. Output coupler 30 provides an output interface between optical circuit 22 and other system devices.

Light input 24 exits input coupler 28 in an optically aligned manner as multiple branched paths including a first path 40 and a second path 42. Paths 40, 42 are incident upon and enter a phase shifter 44. In one embodiment, phase shifter 44 includes an optical switch 46 that is selectively activated to phase shift (or create a phase lag) in the second path 42. Second path 42 is optically phase shifted between a zero degree phase lag (allowing light to pass through phase shifter 44) to a 180 degree phase lag (initiating destructive interference that nullifies signal output from phase shifter 44 for path 42). First path 40 does not include an optical switch, such that signals in first path 40 generally pass through phase shifter 44. In this regard, optical switch 46 creates a relative optical phase shift in the signal 42 relative to the signal 40.

Light input 26 exits input coupler 28 in multiple branched paths, shown as path 50 and path 52, and enter phase shifter 54. Phase shifter 54 includes optical switch 56 and optical switch 58. Optical switches 56, 58 provide a redundant phase shifter configured to initiate a phase lag in one signal relative to another signal.

Path 50 enters phase shifter 54 including optical switch 56. Path 52 enters phase shifter 54 including optical switch 58. Embodiments provide for independently activating optical switch 56 and optical switch 58. In one embodiment, optical switch 56 is activated and optical switch 58 is not activated, such that a relative phase shift for the signal in path 50 is created relative to the optical signal in path 52 (e.g., path 52 passes through phase shifter 54 unaltered).

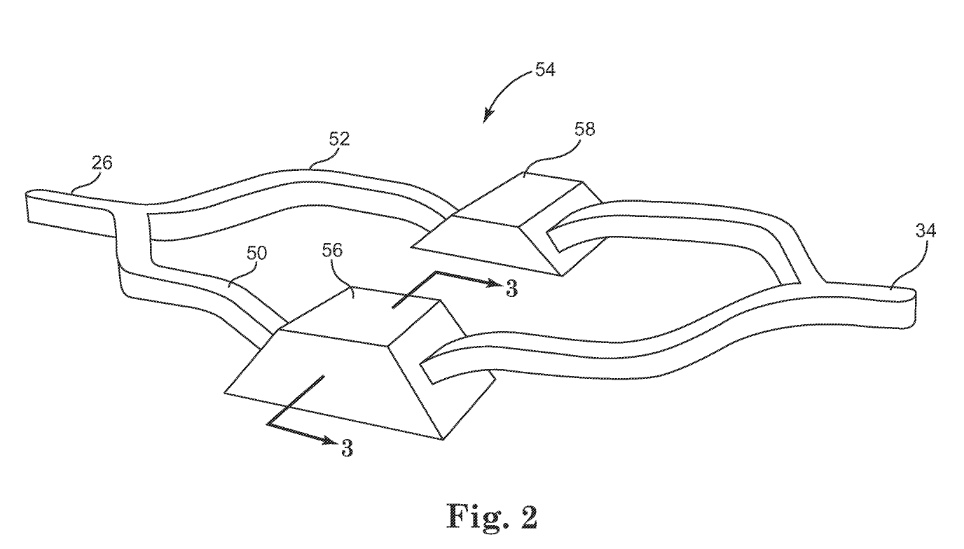

FIG. 2 is a perspective view of phase shifter 54 according to one embodiment. Signal 26 is split between branched paths 50, 52 and exits ultimately as optical signal 34. In one embodiment, one of the signal paths 50, 52 is selectively phase shifted to have an optical phase different that the other signal. For example, in one embodiment optical signal in path 50 is phase shifted by 180 degrees relative to the optical signal in path 52, such that the optical path for the light in path 50 has a longer optical path length compared to path 52. When the signal in path 50 is optically shifted by 180 degrees, the signal transmission is effectively nullified. This phase delay between branches 50, 52 is usefully employed in signal transmission for output signal 34.

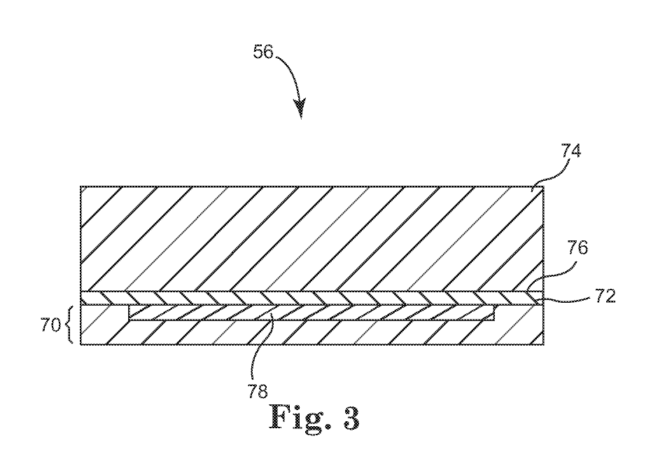

FIG. 3 is a cross-sectional view illustrating one embodiment of an optical switch (e.g., optical switch 56). In one embodiment, optical switch 56 includes a substrate 70, a thin film 72 disposed on substrate 70, and an optical body 74 in contact with thin film 72. In one embodiment, substrate 70 is formed of a material suited for use in opto-electronic circuits, and thin film 72 is deposited as a thin film. Optical body 74 defines a boundary 76 in contact with thin film 72.

In one embodiment, thin film 72 is a thermally responsive layer and substrate 70 optionally includes a thermal or heating element 78 in close proximity to thin film 72. Heating element 78 operates to change thin film 72 between a first index of refraction and a second index of refraction. In other embodiments, heating element 78 operates to change thin film 72 between more than two index of refraction values.

Substrate 70 forms a foundation for switch 56. In one embodiment, substrate 70 is configured to support a plurality of switches in a wafer-like manner and includes a dielectric field such as an oxide field, a nitride field, or other dielectric having suitable thermal etch and electrical characteristics.

Thin film 72 includes chalcogenides or alloy of chalcogenides selected from the elements of Group VI of the periodic table. In one embodiment, thin film 72 includes a chalcogenide compound such as GeSbTe, SbTe, GeTe, or AgInSbTe. In another embodiment, thin film 72 is chalcogen-free, such as GeSb, GaSb, InSb, or GeGaInSb. In other embodiments, thin film 72 includes any suitable material including one or more of the elements Ge, Sb, Te, Ga, As, In, Se, and S. In one embodiment, thin film 72 is selected to have an index of refraction that changes by an one decimal place value in response to a thermal modification/input.

In one embodiment, thin film 72 is deposited onto substrate 70 by chemical vapor deposition (CVD), atomic layer deposition (ALD), metal organic chemical vapor deposition (MOCVD), plasma vapor deposition (PVD), jet vapor deposition (JVD), or other suitable deposition processes. Thin film 72 is deposited onto substrate 70 to have a thickness of less than 1 micron. In another embodiment, thin film 72 is deposited onto substrate 70 to have a thickness of between 0.001 microns to 0.1 microns. One suitable thickness for thin film 72 is 12 nanometers (nm), although other suitable thicknesses are also acceptable.

Thin film 72 enables quick switch response time and utilizes minimal amounts of current in switching switch 56 between transmission states. For example, thin film 72 can be quickly and responsively switched between a generally amorphous and one or more generally crystalline states by the application of thermal energy. In one embodiment, thin film 72 is switched between phases very quickly, for example on the order of nano-seconds (10⁻⁹ seconds), and can be switched reversibly and reproducibly with low voltage inputs.

Thin film 72 changes index of refraction when switching between the generally amorphous to the generally crystalline state(s). In general, the index of refraction for thin film 72 is represented as a complex number that includes a real part (n) and an imaginary party (k). The refractive index for light absorbing materials has a non-zero real portion and a non-zero imaginary portion. The refractive index for light transmitting materials, such as glass, has an imaginary portion (k) that is close to zero (i.e., the absorption of the light in light transmitting materials is about zero).

With regard to thin film 72, the refractive index is represented by a complex number (n, ik), where n is the real portion of the index and k is the imaginary portion of the index (i being the imaginary number represented by the square root of −1). In one embodiment, the refractive index of thin film 72 in the amorphous state is (4.2, i1.2); in the crystalline state the refractive index is (5, i2.9). The real portion (n) and the imaginary portion (k) of the refractive index in the crystalline state are both generally larger than when the thin film 72 is in the amorphous state.

Optical body 74 is made of suitable optical switch material (e.g., silicon oxide). Optical body 74 has a thickness many orders of magnitude larger than thin film 72.

Heating element 78 is deposited onto substrate 70. Heating element 78 includes suitable heating structures, such as metal contacts, electrodes, or other suitable metallic or nonmetallic heating materials. Other layers disposed between heating element 78 and thin film 72 are also acceptable so long as heating element 78 is configured to thermally affect thin film 72.

In one embodiment, other layers are deposited on optical body 74. For example, in one embodiment optical switch 56 includes a circuit stack fabricated layer-upon-layer such that optical switch 56 is located within the stack. Suitable stack layers include oxide layers, nitride layers, insulating layers, and top end pad contact layers.

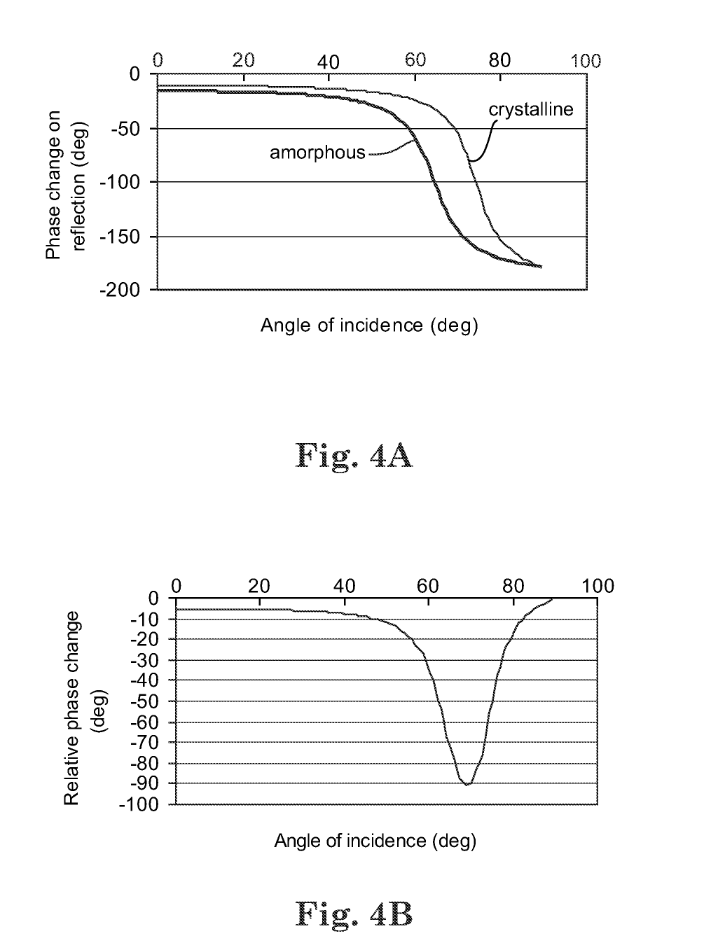

FIG. 4A is a graphical representation of optical phase change in a light signal upon reflection at boundary 76. In general, materials with low absorption have a Brewster's angle. Materials having multi-layers are said to have a pseudo-Brewster's angle. The Brewster's angle is related to the polarization angle of transmitted light. When light moves between two materials having different refractive indices, some light is generally reflected at the boundary. At a particular angle of incidence, light with one particular polarization is not reflected. This angle of incidence associated with light of a given polarization that is not reflected is referred to as the Brewster's angle.

The polarization associated with light at the Brewster's angle has an electric field that is in the same plane as the incidence ray and the surface normal ray. Light with this polarization is said to be parallel-polarized because it is parallel to the plane. When un-polarized light strikes a surface at the Brewster's angle, the reflected light is always perpendicular-polarized. FIG. 4A illustrates that the thin film 72 has a pseudo-Brewster angle that changes depending upon whether thin film 72 is in an amorphous state or a crystalline state. In general, for high index films deposited on low index substrates, the pseudo-Brewster angle increases as illustrated in FIG. 4A.

FIG. 4B is a composite graph of the relative optical phases for reflections at the optical boundary 76. In particular, FIG. 4B is a graph of the difference between the phase change reflection in the crystalline state and the amorphous state. The pseudo-Brewster angle lies in the region generally between 60 degrees angle of incidence and 80 degrees angle of incidence, where the relative phase change is 90 degrees. Other pseudo-Brewster angle characteristics may be selectively achieved by selecting other suitable thin film materials.

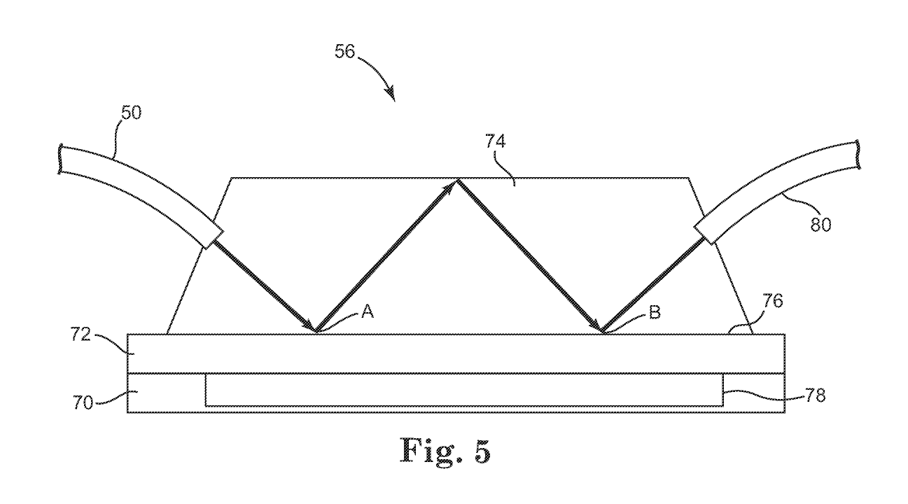

FIG. 5 is a simplified side view illustrating a light wave signal transmitted through optical switch 56 according to one embodiment. Light in path 50 enters optical body 74 and is incident on the boundary 76 of thin film 72. Light from path 50 is selected to be near the pseudo-Brewster angle described above for reflection at point A on boundary 76. Thin film 72 is thermally activated, for example by a current pulse into heater 78, such that thin film 72 is characterized by a crystalline state having an increased refractive index (i.e., an increased complex number refractive index). Light from path 50 is reflected at boundary 76. The reflection experiences a 90 degree relative phase lag at point A and is transmitted through optical body for another reflection at point B. Again, the optical signal experiences a 90 degree relative phase lag at point B such that the exiting signal 80 has experiences a 180 degree relative phase lag relative to signal 50.

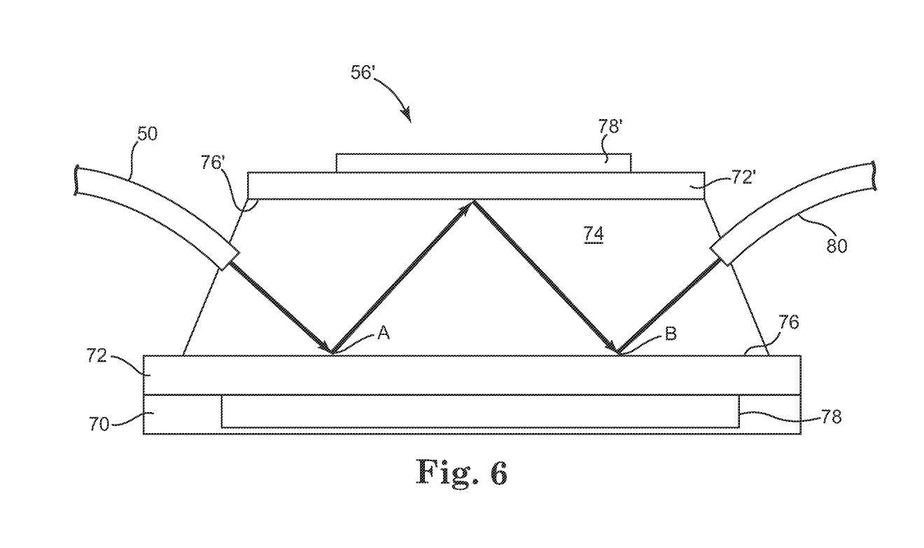

FIG. 6 is a simplified side view illustrating a light wave signal transmitted through another optical switch 56′ according to one embodiment. Optical switch 56′ includes first thin film 72 at first boundary 76 of optical body 74 and a second thin film 72′ at an opposing boundary 76′ of optical body 74 that is generally opposite first thin film 72. In one embodiment, each thin film 72 and 72′ is thermally pulsed by a heater 78 and 78′, respectively. In this manner, the optical signal 80 exiting optical body 74 is configured to have a selected phase lag of between zero and 180 degrees relative phase lag relative to signal 50.

In contrast to the known optical switches that have large volumes of core materials that require large energy inputs to affect a switch in the optical phase, embodiments described above provide an optical switch having small volumes of electrically responsive material that employ small amounts of energy in switching an optical phase of a transmitted signal. In addition, since thin film 72 can be advantageously disposed adjacent to a heating element, such as a lithographically formed electrode, optical response times are greatly reduced, and inhomogeneity effects due to the heating large volumes of material are likewise reduced.

Although specific embodiments have been illustrated and described herein, it will be appreciated by those of ordinary skill in the art that a variety of alternate and/or equivalent implementations may be substituted for the embodiments shown and described without departing from the scope of the present invention. This application is intended to cover any adaptations or variations of the thin film switch elements discussed herein. Therefore, it is intended that this invention be limited only by the claims and the equivalents thereof.

1. An integrated circuit having an optical switch comprising:
an optical body configured to transmit light, the optical body having a boundary; and
a thin film disposed at the boundary, the thin film comprising a phase change material and configured to selectively change a pseudo-Brewster angle of light reflected at the boundary.

2. The integrated circuit of claim 1, comprising:
the thin film having a thickness of less than 1 micron.

3. The integrated circuit of claim 1, comprising:
a heater configured in proximity to the thin film, the heater configured to change the pseudo-Brewster angle of light reflected at the boundary.

4. The integrated circuit of claim 1, comprising:
the thin film configured to reversibly change between at least a first index of refraction and a second index of refraction.

5. (canceled)

6. The integrated circuit of claim 1, where the optical body comprises silicon dioxide.

7. The integrated circuit of claim 1, where the phase change material is reversibly changeable between a substantially amorphous state having a first index of refraction and a substantially crystalline state having a second index of refraction different from the first index of refraction.

8. The integrated circuit of claim 4, comprising:
a heater in close proximity to the thin film, configured to switch the thin film between the first index of refraction and the second index of refraction.

9. An optical system comprising:
a phase shifter having an optical switch comprising an optical body configured to transmit light, the optical body having a boundary, and a thin film disposed at the boundary configured to selectively change a pseudo-Brewster angle of light reflected at the boundary;
a first light transmission path passing through the phase shifter, where the optical switch is positioned along the first light transmission path; and
a second light transmission path.

10. The optical system of claim 9, comprising where the second light transmission path passes through the phase shifter.

11. The optical system of claim 9, comprising:
a second optical switch located along the second optical path, comprising an optical body configured to transmit light, the optical body having a boundary, and a thin film disposed at the boundary configured to selectively change a pseudo-Brewster angle of light reflected at the boundary.

12. The optical system of claim 9, comprising:
the optical switch comprising a heater in proximity to the thin film.

13. The optical system of claim 9, wherein the thin film comprises a phase change material.

14. The optical system of claim 11, wherein the phase change material comprises a chalcogenide free material.

15. The optical system of claim 9, comprising:
the first light transmission path and the second light transmission path are coupled to a light signal input.

16. The optical system of claim 13, comprising:
an input coupler coupled between the phase shifter and the light signal input.

17. The optical system of claim 13, comprising:
an output coupler coupled to the first light transmission path and the second light transmission path.

18. An optical circuit comprising:
an optical switch comprising an optical body configured to transmit light, the optical body having a boundary, a thin film disposed at the boundary configured to selectively change a pseudo-Brewster angle of light reflected at the boundary, and a heater configured in proximity of the thin film configured to change the pseudo-Brewster angle of light reflected at the boundary, the thin film having a thickness of less than 1 micron.

19. The optical circuit of claim 18, comprising:
the thin film configured to reversibly change between at least a first index of refraction and a second index of refraction.

20. The optical circuit of claim 18, where the thin film comprises a phase change material, where the phase change material is reversibly changeable between a substantially amorphous state having a first index of refraction and a substantially crystalline state having a second index of refraction different from the first index of refraction.

21. The optical circuit of claim 18, where the optical body comprises silicon dioxide.

22. The optical circuit of claim 18, comprising where the thin film has a thickness between .1 micron and .001 micron.

23. An integrated circuit comprising:
an optical switch comprising an optical body configured to transmit light, the optical body having a boundary, a thin film disposed at the boundary; and
means for heating the thin film with a heater to change a refractive index of the thin film, the heater operably coupled to the thin film for selectively changing a pseudo-Brewster angle of light reflected at the boundary, the thin film having a thickness of less than 1 micron.

24. (canceled)

25. A method of transmitting optical signals in an optical circuit, the method comprising:
providing the optical circuit with a light guide including a first transmission path and a second transmission path separate from the first path;
providing an optical switch including a thin film along the first transmission path; and
selecting an optical path for light transmission in one of the first and second paths by applying heat to the thin film and modifying a refractive index of the thin film.

26. (canceled)

27. The method of claim 25, wherein selecting an optical path comprises changing a pseudo-Brewster angle of light reflect at a boundary of the thin film.

28. The method of claim 25, wherein selecting an optical path comprises phase shifting by 180 degrees the light entering the first transmission path.
